(19) United States
(12) Patent Application Publication
(10) Pub. No.: US 2008/0262784 A1
(43) Pub. Date: Oct. 23, 2008

(54) Device and a method for monitoring tire pressures of a vehicle with the help of inclinometers

(75) Inventors: Sebastien Massoni, Clermont-Ferrand (FR); Maxime Rolland, Pessat-Villeneuve (FR)

Correspondence Address: FITZPATRICK CELLA HARPER & SCINTO, 30 ROCKEFELLER PLAZA, NEW YORK, NY, 10112, US

(73) Assignee: MICHELIN RECHERCHE ET TECHNIQUE S.A., Granges-Paccot (CH)

(21) Appl. No.: 12/103,034

(22) Filed: Apr. 15, 2008

(30) Foreign Application Priority Data
Apr. 19, 2007 (FR) 07/54571

(51) Int. Cl. G01L 9/00; G01M 17/02

(52) U.S. Cl. 702/138; 73/146

(57) ABSTRACT

The device (12A, 12B) comprises first and second inclinometers (IT1, IR1; IT2, IR2) carried by first and second axles (T1, R1; T2, R2). The inclinometers are designed to measure respective angles of inclination of the first and second geometrical axes of the axles passing through the centers of the wheels carried by each of the axles, about an axis of inclination (ITL; IRL) parallel to a first direction. The device (12A, 12B) includes calculation means (18) suitable for calculating, over a given time interval, a history of an angle of inclination, referred to as an inclinometer history, in particular for each angle of inclination of the first and second axle axes. The device includes means (20) for calculating an indicator from at least two inclinometer histories, referred to as a deviation indicator, which indicator serves to compare the inclinometer histories, in particular the inclinometer histories for the angles of inclination of the first and second axles.

The present invention relates to a device and to a method for monitoring tire pressures of a vehicle with the help of inclinometers.

The invention applies particularly, but not exclusively, to monitoring tire pressures of a tractor and of a trailer of a heavy goods type vehicle.

The term pressure is used to mean the pressure inside a tire and is defined as the force per unit area exerted by a gas on the inside surface of a tire.

It is known, in particular from U.S. Pat. No. 2,155,903, to monitor tire pressures of a vehicle by means of a device that monitors such pressure indirectly.

The vehicle described in U.S. Pat. No. 2,155,903 includes first and second pairs of wheels. The wheels in each pair are transversely-opposite (left and right wheels). The first and second pairs of wheels are carried respectively by first and second axles. The first and second axles define first and second respective geometrical axes referred to as axle axes. Each axle axis passes through the centers of the wheels in the corresponding pair.

The first and second axles carry respective first and second inclinometers. Each of the first and second inclinometers serves to measure an angle of inclination relative to a longitudinal direction of the vehicle respectively for the first or the second axle axis about an inclination axis parallel to said direction.

An under-inflated tire causes the axis of the axle carrying the tire to be inclined about the inclination axis parallel to the longitudinal direction of the vehicle.

The monitoring device described in U.S. Pat. No. 2,155,903 comprises means that are relatively complex, comprising electrical, mechanical, and thermal means that are coupled to one another and connected to the two inclinometers.

The monitoring device of U.S. Pat. No. 2,155,903 is relatively bulky and requires inclinometers that are specific to the intended application.

In addition, the monitoring device of U.S. Pat. No. 2,155,903 requires time-consuming adjustments of the electrical, mechanical, and thermal means.

Finally, the electrical, mechanical, and thermal means of the monitoring device of U.S. Pat. No. 2,155,903 present a relatively large amount of inertia. Paradoxically, that inertia has the advantage of avoiding the angles of inclination varying under the effects of the axles tilting in the roll direction in untimely manner as the result of the surface of the road, in particular when the road is superelevated, such that detecting under-inflated tires from the angles of inclination is not disturbed by the untimely roll direction tilting of the axles.

A particular object of the invention is to provide a device for monitoring tire pressures that is relatively standard and easy to install on a vehicle, in particular of the heavy good type, making it possible in reliable manner to detect any under-inflated tire, where such detection is not disturbed by variations in the angles of inclination (and in particular superelevations) and irregularities of the road surface.

To this end, the invention provides a device for monitoring tire pressures of a vehicle, the vehicle comprising:
a first pair of transversely-opposite wheels, each fitted with a tire, carried by a first axle defining a geometrical axis referred to as the first axle axis passing through the centers of the wheels of said first pair; and
a second pair of transversely-opposite wheels, each fitted with a tire, carried by a second axle defining a geometrical axis referred to as the second axle axis passing through the centers of the wheels of said second pair and substantially parallel to the first wheel axis;

the device comprising first and second inclinometers respectively carried by the first and second axles, each serving to measure an angle of inclination of a respective one of the first and second axle axes relative to a first direction about an inclination axis parallel to said first direction;

the device further comprising:
calculation means suitable, over a given time interval, for calculating an inclination angle history referred to as an inclinometer history, in particular for the angles of inclination of the first and second axle axes; and
means for calculating an indicator from at least two inclinometer histories and referred to as a deviation indicator, which indicator serves to compare two inclinometer histories, in particular the inclinometer histories of the angles of inclination of the first and second axle axes.

The means for calculating an inclinometer history indicator as proposed by the invention enable under-inflation to be detected from said indicator, which indicator is selected to be relatively independent of the effect of any untimely tilting of the axles in the roll or pitch directions (e.g. by taking an average of the inclinometer differences), thus making it possible to detect under-inflation reliably without being disturbed by untimely tilting of the axles, even when using standard inclinometers, such as electrolytic inclinometers, having a response to variations in angle of inclination that is fast and sensitive to untimely tilting of the axles.

The invention thus makes it possible to use standard inclinometers that can be installed quickly on any type of vehicle as defined above, even though standard inclinometers are sensitive to variations in angle of inclination (and in particular variations in superelevation) and to irregularities of the road surface.

Where appropriate, the vehicle may include a third pair of transversely-opposite wheels, each fitted with a tire and carried by a third axle defining a geometrical axis referred to as the third axle axis that passes through the centers of the wheels of this third pair and that is substantially parallel to the first and second axle axes. Under such circumstances, the device includes a third inclinometer carried by the third axle for measuring the angle of inclination of the third axle axis about an inclination axis parallel to the first direction.

In an embodiment, at least one inclinometer serves to measure an angle of inclination of the axis of the axle carrying the inclinometer relative to a second direction about an inclination axis parallel to said second direction.

Advantageously, the first direction corresponds substantially to a longitudinal direction of the vehicle and the second direction corresponds substantially to a transverse direction of the vehicle.

The first and second directions as selected in this way make it possible to maximize the measurement sensitivity of each of the inclinometers. Since the longitudinal and transverse directions correspond substantially to the directions about which the axle axis is liable to become inclined as a result of under-inflation of one of the tires carried by the axle, any variation in the angle of inclination of the axle axis either about the inclination axis parallel to the longitudinal direction, or about the inclination parallel to the transverse direction, is substantially equal to the angle measured by the inclinometer relative to the longitudinal or the transverse direction.

Optionally, the vehicle includes at least one guide arm connecting an axle to a transverse pivot axis associated with the chassis of the vehicle so that the axis of this suspended axle is substantially parallel to the pivot axis and can oscillate about said pivot axis, the pivot axis forming the inclination axis parallel to the transverse direction for the inclinometer carried by the suspended axle.

It is particularly pertinent to measure the angle of inclination of the axle axis relative to the transverse direction of the vehicle, about the pivot axis. The closer the axle axis is to the pivot axis, the more under-inflation of one of the tires carried by the axle will lead to a large oscillation of the axle axis about the pivot axis. A large oscillation of the axle axis about the pivot axis leads to a large angle of inclination of the axle axis about the pivot axis. This increases the sensitivity of measurement of each of the angles relative to the transverse direction.

Advantageously, the axles are not secured together in pairs.

It is thus possible to measure independent inclinations of the axle axes about first and second directions.

Preferably, at least one inclinometer is of the electrolytic type.

An inclinometer of the electrolytic type presents the advantage of being practically insensitive to the effects of vibrations at frequencies greater than 5 hertz (Hz), or greater than 50 Hz.

In addition, an inclinometer of this type is generally reliable and stable over time, thereby limiting any maintenance operations. In addition, the low cost of an inclinometer of this type limits the cost of a monitor device that includes the inclinometer.

Finally, an inclinometer of electrolytic type is compact, thereby reducing the overall size of the monitor device in the vehicle.

Advantageously, the vehicle is a trailer or a tractor of a heavy goods type vehicle.

With a heavy goods type vehicle (tractor and trailer), it is describe to detect very quickly a tire that is under-inflated. A tire of a heavy goods type vehicle is subjected to heavy loads, and failure to detect an under-inflated tire can lead to the tire being damaged. The device of the invention is thus advantageous since it makes it possible to detect under-inflation quickly, and in any event before the tire becomes damaged.

By means of the monitor device of the invention, the tire pressures of a heavy goods type vehicle can be tracked sufficiently closely for there to be no need to double the number of tires of each axle in order to mitigate possible failure to detect an under-inflated tire. Thus, the invention makes it possible for each axle to have only two tires instead of four. Where appropriate, the inclinometer history of an angle is an average of successive measurements of said angle calculated over a first time interval, and the deviation indicator is an average of the differences between inclinometer histories as calculated between two axle axes relative to a common direction and over a second time interval.

The invention also provides a method of monitoring tire pressures of a vehicle by means of a device as defined above, the method comprises the following steps:
calculating respective inclinometer histories for the angles of inclination of two axle axes;
calculating a deviation indicator from at least two inclinometer histories; and
when the value of the indicator exceeds, in absolute value, a non-zero threshold, the sign of the indicator is used to determine a tire that is under-inflated or a set of tires that are suspect.

In a first embodiment of the invention, first, second, and third inclinometer histories are calculated relative to the first direction respectively for the angles of inclination of the first, second, and third axle axes. Under such circumstances, the first, second, and third deviation indicators relative to the first direction are calculated respectively from:
the first and second inclinometer histories;
the second and third inclinometer histories; and
the first and third inclinometer histories.

When two of the indicators relative to the first direction, and taken from the first, second, and third indicators relative to the first direction, both exceed in absolute value, a non-zero threshold, the method comprises the steps of:
determining a set of two suspect tires from the two indicators exceeding, in absolute value, the non-zero threshold; and
determining an under-inflated tire from the set of two suspect tires from a sign of one of the two indicators that exceeds, in absolute value, the non-zero threshold.

In a variant, the method comprises the steps of:
determining a set of four suspect tires from a first one of the two indicators exceeding, in absolute value, the non-zero threshold; and
determining an under-inflated tire from the set of four suspect tires from the sign of the second of the two indicators that exceeds, in absolute value, the non-zero threshold.

In a second embodiment of the invention, the following are calculated: firstly, from the first and second inclinometer histories relative to the first direction, respective angles of inclination of the first and second axle axes relative to said first direction; and secondly, from the first and second inclinometer histories relative to the second direction, respective angles of inclination of the first and second axle axes relative to said second direction. A deviation indicator is calculated relative to the first direction from the first and second inclinometer histories relative to the first direction, and a deviation indicator is calculated relative to the second direction from the first and second inclinometer histories relative to the second direction.

When each of the two indicators relative to the first and second directions exceeds, in absolute value, a respective non-zero threshold relative to the first direction and a non-zero threshold relative to the second direction, the method comprises the steps of:
determining a set of two suspect tires from the sign of one of the two indicators, referred to as the first reference indicator, that exceeds, in absolute value, the corresponding non-zero threshold; and
determining an under-inflated tire from the set of two suspect tires from the sign of the other one of the indicators that exceeds, in absolute value, the corresponding non-zero threshold, and referred to as the second reference indicator.

In a first example of this second embodiment of the method, the first reference indicator is the indicator relative to the longitudinal direction of the vehicle, and the set of two suspect tires comprises two transversely-opposite tires carried by two different axles. The second reference indicator is the indicator relative to the transverse direction.

In a second example of this second embodiment of the method, the first reference indicator is the indicator relative to the transverse direction of the vehicle, and the set of two suspect tires comprises two transversely-opposite tires carried by the same axle. The second reference indicator is the indicator relative to the longitudinal direction.

The invention can be better understood on reading the following description given purely by way of non-limiting example and made with reference to the drawings, in which:

FIG. 1 is a diagrammatic view in an X,Z plane of a heavy goods type vehicle provided with two devices constituting first and second embodiments of the invention for monitoring tire pressures;

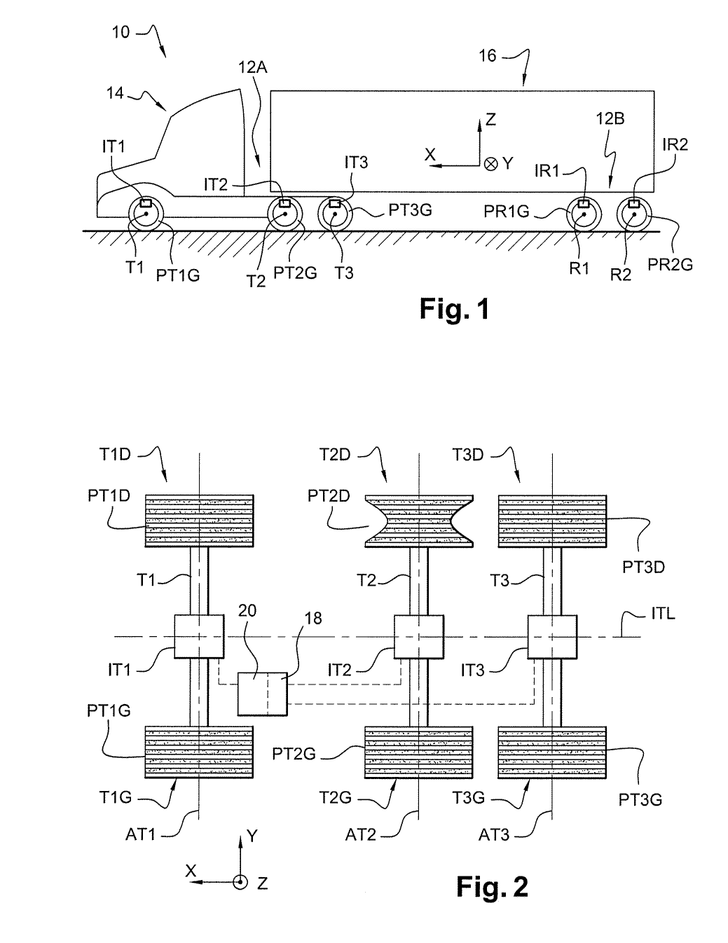

FIG. 2 is a diagrammatic view in an X,Y plane of three axles of a vehicle tractor as shown in FIG. 1 provided with a device constituting the first embodiment of the invention;

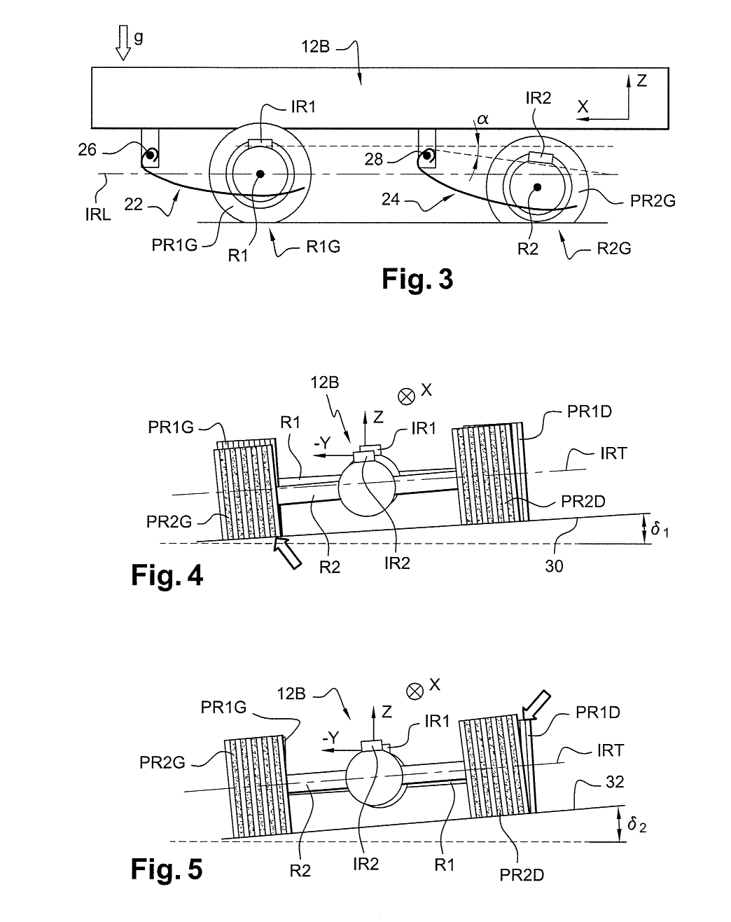

FIG. 3 is a detail view in the X,Z plane of two axles of a trailer of the FIG. 1 vehicle provided with a device constituting the second embodiment of the invention;

FIG. 4 is a diagrammatic view in the Y,Z plane of the two axles shown in FIG. 3, with an under-inflated tire; and

FIG. 5 is a view analogous to FIG. 4 in which the under-inflated tire is different from the under-inflated tire in FIG. 4.

In the figures, there can be seen three mutually orthogonal axes X, Y, Z corresponding to the conventional orientations for a vehicle: longitudinal (X); transverse (Y); and vertical (Z).

FIG. 1 shows a heavy goods type vehicle 10 having two devices constituting first and second embodiments of the invention and given respective references 12A and 12B.

The vehicle 10 comprises a tractor 14 fitted with the device 12A constituting the first embodiment, and a trailer 16 fitted with the device 12B constituting the second embodiment.

As shown in FIGS. 1 and 2, the tractor 14 has first, second, and third axles given respective references T1, T2, and T3. These three axles are not secured to one another in pairs.

The first axle T1 carries a first pair of transversely-opposite wheels. The right and left wheels carried by the axle T1 are given respective references T1D and T1G. Each wheel T1D, T1G is fitted with a tire PT1D, PT1G. The axle T1 defines a geometrical axis AT1, referred to as the first axle axis. This axis AT1 passes through the centers of the wheels T1D and T1G of the first pair.

Elements relating to the second and third axles T2 and T3 are designated by references that can be deduced mutatis mutandis from the references for elements relating to the first axle T1. The axle axes AT1, AT2, and AT3 are substantially parallel in pairs.

The device 12A constituting a first embodiment of the invention comprises first, second, and third inclinometers IT1, IT2, and IT3 carried respectively by the first, second, and third axles T1, T2, and T3. These inclinometers IT1, IT2, and IT3 are also shown diagrammatically in FIG. 1, and each of them serves to measure an angle of inclination relative to a first direction respectively of the first, second, or third axle axis AT1, AT2, and AT3, about an inclination axis ITL parallel to said first direction. In the example shown in FIG. 2, the first direction corresponds substantially to the longitudinal direction of the tractor, parallel to the X axis.

The inclinometers IT1, IT2, and IT3 are preferably of the electrolytic type.

The device 12A also includes calculator means 18 suitable for calculating, over a given time interval Δ₁, a history of an inclination angle, referred to as an inclinometer history. The angle of inclination is taken from amongst the angles of inclination of the first, second, and third axle axes AT1, AT2, and AT3 about the inclination axis ITL parallel to the longitudinal direction of the vehicle. Each inclinometer history corresponding to each angle of inclination of the first, second, and third axle axes AT1, AT2, and AT3 is given a respective reference VL1, VL2, and VL3.

The device 12A also includes means 20 for calculating an indicator, referred to as the deviation indicator, on the basis of at least two inclinometer histories. In the example described, the inclinometer history of an angle is a mean of successive measurements of said angle calculated over the time interval Δ₁, and the deviation indicator is a mean of the differences between the inclinometer histories as calculated between two axle axes relative to a given direction and over a second time interval Δ₂.

The time intervals Δ₁ and Δ₂ are selected to be sufficiently long to ensure that the indicator is reliable in indicating tire under-inflation, if any. Nevertheless, these time intervals Δ₁ and Δ₂ are selected to be sufficiently short to ensure that if a tire does become under-inflated, then that is indicated relatively quickly. Specifically, Δ₁ is equal to 30 seconds and Δ₂ is equal to 15 minutes.

The device 12A constituting the first embodiment of the invention serves to implement a method in a first embodiment having main steps as described below.

In this first embodiment, first, second, and third inclinometer histories VL1, VL2, and VL3 are calculated relating to the longitudinal direction.

The first inclinometer history VL1 is the inclinometer history of the angle of the first axle axis AT1 relative to the longitudinal direction. The second inclinometer history VL2 is the inclinometer history of the angle of the second axle axis AT2 relative to the longitudinal direction. The third inclinometer history VL3 is the inclinometer history of the angle of the third axle axis AT3 relative to the longitudinal direction.

In order to detect any under-inflation of one of the tires carried by the axles T1, T2, and T3, first, second, and third deviation indicators are calculated relative to the first direction and respectively designated by λ_{T1,2}, λ_{T2,3}, and λ_{T1,3}, with these indicators being calculated respectively from the first and second inclinometer histories VL1, VL3, from the second and third inclinometer histories VL2, VL3, and from the first and third inclinometer histories VL1, VL3.

In general, the deviation indicator calculated from the inclinometer histories relative to the longitudinal direction for the angles of axle axes i and j is written λ_{Ti,j}.

When two of the indicators λ_{T1,2}, λ_{T2,3}, λ_{T1,3} both exceed in absolute value a non-zero threshold ε_{L}, a set of two suspect tires is determined from those two indicators that exceed in absolute value the non-zero threshold. The threshold ε_{L} is selected in such a manner as to obtain desired sensitivity in detection of under-inflation.

In the example shown in FIG. 2, the indicators λ_{T1,2} and λ_{T2, 3} both exceed in absolute value the threshold ε_{L}. The indicator λ_{T1,3} does not exceed, in absolute value, the threshold ε_{L}. The set of two suspect tires is thus constituted by the two tires carried by the axle that is common to the two indicators λ_{T1,2} and λ_{T2,3}, i.e. the axle T2. The two suspect tires are therefore PT2D and PT2G.

Which tire in the set of two suspect tires is the under-inflated tire is determined from a sign of one of the two indicators λ_{T1,2} and λ_{T2,3} that exceed, in absolute value, the non-zero threshold ε_{L}.

When the device 12A is installed on the tractor 14, the inclinometers IT1 and IT2 are adjusted in such a manner that if the indicator λ_{T1,2} is positive, then the tires PT1D and PT2G form the set of two suspect tires. Conversely, if the indicator λ_{T1,2} is negative, the tires PTLG and PT2D form the set of two suspect tires. Analogously, the inclinometer IT3 is adjusted so that if λ_{T2,3} is positive, then the tires PT2D and PT3G form the set of such suspect tires, and if λ_{T2,3} is negative, then the tires PT2G and PT3D form the set of two suspect tires. Finally, if the indicator λ_{T1,3} is positive, then the tires PT1D and PT3G form the set of two suspect tires and if λ_{T1,3} is negative, then the tires PT1G and PT3D form the set of two suspect tires.

In the example shown in FIG. 2, the sign of λ_{T1,2} is negative. Thus, the under-inflated tire on the axle T2 is the tire PT2D. It should be observed that it is also possible to determine the under-inflated tire from the sign of λ_{T2,3}. Since the sign of λ_{T2,3} is positive, then the under-inflated tire on the axle T2 is indeed the tire PT2D.

In a variant of the first embodiment of the method of the invention, a set of four suspect tires is determined from a first of the two indicators λ_{T1,2} and λ_{T2,3} exceeding in absolute value the threshold ε_{L}.

Thus, in the example shown in FIG. 2, since the indicator λ_{T1,2} exceeds, in absolute value, the threshold ε_{L}, the under-inflated tire is either on axle T1 or on axle T2.

Which tire in the set of four tires carried by the axles T1 and T2 is under-inflated is determined from a sign of the second of the two indicators exceeding, in absolute value, the non-zero threshold ε_{L}.

Since the sign of λ_{T2,3} is positive and the under-inflated tire is either on axle T1 or on axle T2, the under-inflated tire is therefore PT2D.

With reference to FIGS. 1 and 3 to 5, there follows a description of the device 12B constituting a second embodiment of the invention. In this embodiment, elements that are analogous to those of the device 12A constituting the first embodiment are given references that are identical.

As shown in FIGS. 1 and 3 to 5, the trailer 16 has first and second axles respectively designated by references R1 and R2. The two axles R1 and R2 are not secured to each other.

The first axle R1 carries a first pair of transversely-opposite wheels. The right and left wheels carried by the axle R1 are respectively referenced R1D and R1G. Each wheel R1D, R1G is fitted with a tire PR1D, PR1G. The axle R1 defines a geometrical axis AR1, referred to as the first axle axis. This axis AR1 passes through the centers of the wheels R1B and R1G of the first pair.

Elements relating to the second axle R2 are designated by references that can be deduced mutatis mutandis from the references for the elements relating to the first axle R1. The axle axes RT1 and RT2 are substantially mutually parallel.

The device 12B comprises first and second inclinometers IR1, IR2 carried respectively by the first and second axles R1 and R2.

Each inclinometer IR1, IR2, also shown diagrammatically in FIG. 1, serves as in the first embodiment to measure an angle of inclination relative to the longitudinal direction of the axis of the axles carrying the inclinometer about an inclination axis IRL parallel to the longitudinal direction of the trailer.

Nevertheless, in this second embodiment, each inclinometer IRT, IR2 is also used to measure an angle of inclination α of the axis of the axle carrying the inclinometer relative to a second direction about an inclination axis IRT that is parallel to said second direction. In the embodiment shown in FIGS. 1 and 3 to 5, the second direction corresponds substantially to a transverse direction relative to the vehicle, i.e. parallel to the Y axis.

The inclinometers IR1 and IR2 are preferably of the electrolytic type.

As shown in detail in FIG. 3, the trailer has two guide arms 22 and 24 respectively connecting the axles R1 and R2 to the chassis. Each guide arm 22, 24 connects a corresponding axle R1, R2 to a transverse pivot axis 26, 28 connected to a chassis of the vehicle 16. Specifically, each guide arm 22, 24 is formed by a half blade. Each guide arm could also use a plurality of arms. In this way, the axle axes AR1 and AR2 are suspended and substantially parallel respectively to the pivot axes 26 and 28. Each of the axes AR1 and AR2 can thus oscillate about the corresponding axis 26 or 28. Each of the axes 26 and 28 thus forms, for each inclinometer IR1 and IR2 carried by each of the suspended axles R1 and R2, the inclination axis IRT that is parallel to the transverse direction relative to the trailer.

The device 12B constituting the second embodiment of the invention serves to implement a method constituting a second embodiment of the invention having main steps that are described below.

Using the means 18 for calculating an inclinometer history and the means 20 for calculating an indicator, first and second inclinometer histories VL1, VL2 are calculated relative to the longitudinal direction of the trailer for the angles of inclination of the first and second axle axes AR1 and AR2 relative to said longitudinal direction. First and second inclinometer histories VT1, VT2 are also calculated relative to the transverse direction of the trailer for the angles of inclination of the first and second axle axes AR1, AR2 relative to said transverse direction.

From the first and second inclinometer histories VL1, VL2 relative to the longitudinal direction, a deviation indicator referenced λ_{R} is calculated relative to the longitudinal direction. A deviation indicator relative to the transverse direction is also calculated from the first and second inclinometer histories VT1, VT2 relative to the transverse direction and written τ_{R}.

In a manner analogous to the notation used for the indicators λ_{R}, the deviation indicator calculated from the inclinometer histories of the angles of the axle axes i and j relative to the transverse direction are written τ_{Ri,j}.

In the event of a tire being under-inflated, the axis of the axle carrying the under-inflated tire forms respective angles about the inclination axes IRL and IRT that are parallel respectively to the longitudinal direction and to the transverse direction of the trailer 16.

When the indicator relative to the longitudinal direction λ_{R1,2} exceeds, in absolute value, the non-zero threshold ε_{L} relative to the longitudinal direction, and when the indicator relative to the transverse direction τ_{R1,2} exceeds, in absolute value, a non-zero threshold ε_{T} relative to the transverse direction, then a set of two suspect tires is initially determined on the basis of the sign of one of the two indicators, referred to as the first reference indicator, that exceeds, in absolute value, the corresponding threshold ε_{L} or ε_{T}.

Specifically, the first reference indicator is the indicator λ_{R1,2} relative to the longitudinal direction of the vehicle.

The sign of λ_{R1,2} is not sufficient for determining which tire is under-inflated, as can be seen from the examples of FIGS. 4 and 5. In FIGS. 4 and 5, there are shown two axles R1 and R2 traveling respectively on roads 30 and 32. These roads 30 and 32 present different angles of inclination relative to the horizontal, and respectively referenced δ₁ and δ₂.

In the example shown in FIG. 4, the tire PR2D is under-inflated. In the example shown in FIG. 5, the tire PR1G is under-inflated. Nevertheless, in both cases the indicator λ_{R1,2} is the same.

In the example shown in FIG. 3, the set of two suspect tires thus comprises two transversely-opposite tires carried by two different axles. Specifically, since λ_{R1,2} is positive the set comprises the tires PR1D and PR2G.

Which tire in the set of two suspect tires PR1D and PR2G is under-inflated is determined from the sign of the second reference indicator τ_{R1,2} exceeding, in absolute value, the corresponding threshold ε_{T}.

On installation of the device 12B on the trailer 16, the inclinometers IR1 and IR2 are adjusted in a manner analogous to the inclinometers IT1 and IT2. In addition, the inclinometers IR1 and IR2 are adjusted in such a manner that if the indicator τ_{R1,2} is positive, then the tires PR2D and PR2G form the set of two suspect tires. Conversely, if the indicator τ_{R1,2} is negative, then the tires PR1G and PR1D form the set of two suspect tires.

In the example described, τ_{R1,2} is positive, so the under-inflated tire is the tire PR2G, as shown in FIG. 3.

In a second variant of the second embodiment of the method of the invention, the first reference indicator is the indicator τ_{R1,2} relative to the transverse direction and the second reference indicator is the indicator λ_{R1,2} relative to the longitudinal direction.

The set of two suspect tires thus comprises two transversely-opposite tires carried by the same axles. Specifically, since τ_{R1,2} is positive, the two suspect tires are the tires carried by the axle R2.

In addition, since τ_{R1,2} is positive, the under-inflated tire is the tire PR2G.

In the first and second embodiments, the devices 12A and 12B serve to detect when a tire is under-inflated by about 30% relative to its recommended pressure. Such under-inflation corresponds to a deviation indicator λ_{T}, λ_{R}, τ_{R} equal to about 0.3° in absolute value, i.e. to extra sag of the under-inflated tire by about 10 millimeters (mm).

It should be observed that the methods constituting the first and second embodiments of the invention, and variants thereof, include steps in common.

In all of the embodiments, an inclinometer history for the angles of inclination of two axle axes is calculated. A deviation indicator is also calculated from at least one of the two inclinometer histories.

When the absolute value of the indicator exceeds the threshold ε, an under-inflated tire, or a set of suspected tires including the under-inflated tire, is determined as a function of the sign of the indicator.

The invention is not limited to the two embodiments described above.

In the first embodiment, if the three axles T1, T2, and T3 carry inclinometers for measuring an angle relative to the transverse direction, and if they are suspected in the manner described for the axles R1 and R2, then it is possible to monitor the pressures of the tires carried by the axles T1, T2, and T3 from the inclinations of the axle axes relative to the transverse direction of the vehicle.

The corresponding method would then use indicators τ_{T1,2}, τ_{T1,3}, and τ_{T2,3}.

In addition, the three axles T1, T2, and T3 could carry inclinometers, each designed to measure two angles of inclination relative both to the longitudinal direction and to the transverse direction. The first and second embodiments of the method of detection could then be performed simultaneously. The signal indicating that an under-inflated tire has been detected could then be triggered by whichever embodiment of the method is the first to detect under-inflation.

1. A device (12A, 12B) for monitoring tire pressures of a vehicle (10, 14, 16), the vehicle comprising:
a first pair of transversely-opposite wheels, each fitted with a tire, carried by a first axle (T1; R1) defining a geometrical axis referred to as the first axle axis (AT1; AR1) passing through the centers of the wheels of said first pair; and
a second pair of transversely-opposite wheels, each fitted with a tire, carried by a second axle (T2; R2) defining a geometrical axis referred to as the second axle axis (AT2; AR2) passing through the centers of the wheels of said second pair and substantially parallel to the first wheel axis (AT1, AR1);
the device (12A, 12B) comprising first and second inclinometers (IT1, IR1; IT1, IR2) respectively carried by the first and second axles (T1, R1; T2, R2), each serving to measure an angle of inclination of a respective one of the first and second axle axes relative to a first direction about an inclination axis (ITL; IRL) parallel to said first direction;
the device (12A, 12B) further comprising:
calculation means (18) suitable, over a given time interval, for calculating an inclination angle history (VL1, VL2, VL3; VT1, VT2) referred to as an inclinometer history, in particular for the angles of inclination of the first and second axle axes; and
means (20) for calculating an indicator (λ_{Ti,j}, τ_{Ti,j}; λ_{Ri,j}, τ_{Ri,j}) from at least two inclinometer histories (VL1, VL2, VL3; VT1, VT2) and referred to as a deviation indicator, which indicator serves to compare two inclinometer histories, in particular the inclinometer histories (VL1, VL2, VL3; VT1, VT2) of the angles of inclination of the first and second axle axes.

2. A device (12A) according to claim 1, in which, for the vehicle (10, 14, 16) comprising:
a third pair of transversely-opposite wheels, each fitted with a tire, carried by a third axle (T3) defining a geometrical axis referred to as the third axle axis (AT3) passing through the centers of the wheels of said third pair and substantially parallel to the first and second wheel axes (AT1; AT2);
the device (12A) includes a third inclinometer (IT3) carried by the third axle (T3) to measure an angle of inclination of the third axle axis (AT3) about an inclination axis (ITL) parallel to the first direction.

3. A device (12B) according to claim 1, in which at least one inclinometer (IR1, IR2) serves to measure an angle of inclinometer (α) of the axis of the axle carrying the inclination relative to a second direction about an inclination axis (IRT) parallel to said second direction.

4. A device (12A, 12B) according to claim 3, in which the first direction corresponds substantially to a longitudinal direction of the vehicle and the second direction corresponds substantially to a transverse direction of the vehicle.

5. A device (12B) according to claim 4, the vehicle (10, 14, 16) including at least one guide arm (22, 24) connecting an axle (R1, R2) to a transverse pivot axis (26, 28) connected to a chassis of the vehicle in such a manner that the axis (AR1, AR2) of said suspended axle is substantially parallel to the pivot axis (26, 28) and can oscillate about said pivot axis (26, 28), the pivot axis (26, 28) forming an inclination axis (IRT) parallel to the transverse direction for the inclinometer carried by the suspended axle.

6. A device (12A, 12B) according to any preceding claim, in which the axles (T1, T2, T3; R1, R2) are not secured together in pairs.

7. A device (12A, 12B) according to any preceding claim, in which at least one inclinometer (IT1, IT2, IT3; IR1, IR2) is of the electrolytic type.

8. A device (12A, 12B) according to any preceding claim, in which the vehicle (10, 14, 16) is a trailer (16) or a tractor (14) of a heavy goods type vehicle (10).

9. A device (12A, 12B) according to any preceding claim, in which:
the inclinometer history (VL1, VL2, VL3; VT1, VT2) of an angle is a mean of successive measurements of said angle calculated over a first time interval (Δ₁); and
the deviation indicator (λ_{Ti,j}, τ_{Ti,j}; λ_{Ri,j}, τ_{Ri,j}) is a mean of differences of the inclinometer histories (VL1, VL2, VL3; VT1, VT2) calculated between two axle axes relative to a common direction and over a second time interval (Δ₂).

10. A method of monitoring tire pressures of a vehicle (10, 14, 16) by means of a device (12A, 12B) according to any preceding claim, the method comprising the following steps:
calculating respective inclinometer histories (VL1, VL2, VL3; VT1, VT2) for the angles of inclination of two axle axes (AT1, AT2, AT3; AR1, AR2);
calculating a deviation indicator (λ_{Ti,j}, τ_{Ti,j}; λ_{Ri,j}, τ_{Ri,j}) from at least two inclinometer histories (VL1, VL2, VL3; VT1, VT2); and
when the value of the indicator (λ_{Ti,j}, τ_{Ti,j}; λ_{Ri,j}, τ_{Ri,j}) exceeds, in absolute value, a non-zero threshold (ε_{L}, ε_{T}) the sign of the indicator (λ_{Ti,j}, τ_{Ti,j}; λ_{Ri,j}, τ_{TRi,j}) is used to determine a tire that is under-inflated or a set of tires that are suspect.

11. A method according to claim 10, for monitoring tire pressures of a vehicle (14) by means of a device (12A) according to claim 2, the method comprising the following steps:
calculating first, second, and third inclinometer histories (VL1, VL2, VL3) relative to the first direction for the inclination angles of the first, second, and third axle axes (AT1, AT2, AT3), respectively;
calculating first, second, and third deviation indicators (λ_{T1,2}, λ_{T2,3}, λ_{T1,3}) relative to the first direction, respectively from:
the first and second inclinometer histories (VL1, VL2),
the second and third inclinometer histories (VL2, VL3); and
the first and third inclinometer histories (VL1, VL3); and
when two of the indicators (λ_{T1,2}, λ_{T2,3}, λ_{T1,3}) relating to the first direction taken from the first, second, and third indicators (λ_{T1,2}, λ_{T2,3}, λ_{T1,3}) relating to the first direction both exceed, in absolute value, a non-zero threshold (εL):
determining a set of two suspect tires from the two indicators (λ_{T1,2}, λ_{T2,3}, λ_{T1,3}) exceeding, in absolute value, the non-zero threshold (ε_{L}); and
determining an under-inflated tire from the set of two suspect tires from a sign of one of the two indicators (λ_{T1,2}, λ_{T2,3}, λ_{T1,3}) that exceeds, in absolute value, the non-zero threshold (ε_{L}).

12. A method according to claim 10, for monitoring tire pressures of a vehicle (14) by means of a device (12A) according to claim 2, the method comprising the following steps:
calculating first, second, and third inclinometer histories (VL1, VL2, VL3) relative to the first direction for the inclination angles of the first, second, and third axle axes (AT1, AT2, AT3), respectively;
calculating first, second, and third deviation indicators (λ_{T1,2}, λ_{T2,3}, λ_{T1,3}) relative to the first direction, respectively from:
the first and second inclinometer histories (VL1, VL2);
the second and third inclinometer histories (VL2, VL3); and
the first and third inclinometer histories (VL1, VL3); and
when two of the indicators (λ_{T1,2}, λ_{T2,3}, λ_{T1,3}) relating to the first direction taken from the first, second, and third indicators (λ_{T1,2}, λ_{T2,3}, λ_{T1,3}) relating to the first direction both exceed, in absolute value, a non-zero threshold (ε_{L}):
determining a set of four suspect tires from a first one of the two indicators (λ_{T1,2}, λ_{T2,3}, λ_{T1,3}) exceeding, in absolute value, the non-zero threshold (ε_{L}); and
determining an under-inflated tire from the set of four suspect tires from the sign of the second of the two indicators (λ_{T1,2}, λ_{T2,3}, λ_{T1,3}) that exceeds, in absolute value, the non-zero threshold (ε_{L}).

13. A method according to claim 10, for monitoring tire pressures of a vehicle (14) by means of a device (12B) according to claim 3, the method comprising the following steps:
calculating first and second inclinometer histories (VL1, VL2) relative to the first direction for the angles of inclination of the first and second axle axes (AR1, AR2) respectively, relative to said first direction;
calculating first and second inclinometer histories (VT1, VT2) relative to the second direction for the angles of inclination of the first and second axle axes (AR1, AR2) respectively, relative to said second direction;
calculating a deviation indicator (λ_{R1,2}, τ_{R1,2}) relative to the first direction from the first and second inclinometer histories (VL1, VL2), relative to the first direction;
calculating a deviation indicator (λ_{R1,2}, τ_{R1,2}) relative to the second direction from the first and second inclinometer histories (VT1, VT2), relative to the second direction; and
when each of the two indicators (λ_{R1,2}, τ_{R1,2}) relative to the first and second directions respectively exceeds, in absolute value, a non-zero threshold (ε_{L}) relative to the first direction and a non-zero threshold (ε_{T}) relative to the second direction:
determining a set of two suspect tires from the sign of one of the two indicators (λ_{R1,2}, τ_{R1,2}), referred to as the first reference indicator, that exceeds, in absolute value, the corresponding non-zero threshold (ε_{L}, ε_{T}); and
determining an under-inflated tire from the set of two suspect tires from the sign of the other one of the indicators (λ_{T1,2}, τ_{R1,2}) that exceeds, in absolute value, the corresponding non-zero threshold (ε_{L}, ε_{T}), and referred to as the second reference indicator.

14. A method according to claim 13 of monitoring tire pressures of a vehicle (16) by means of a device (12B) according to claim 4, in which:
the first reference indicator is the indicator (λ_{R1,2}) relative to the longitudinal direction of the vehicle, the set of two suspect tires comprising two transversely-opposite tires carried by two different axles; and
the second reference indicator is the indicator (τ_{R1,2}) relative to the transverse direction.

15. A method according to claim 13 for monitoring tire pressures of a vehicle (16) by means of a device (12B) according to claim 4, in which:
the first reference indicator is the indicator (τ_{R1,2}) relative to the transverse direction of the vehicle, the set of two suspect tires comprising two transversely-opposite tires carried by the same axle; and
the second reference indicator is the indicator (λ_{R1,2}) relative to the longitudinal direction.
